(19) United States
(12) Patent Application Publication
(10) Pub. No.: US 2010/0070356 A1
(43) Pub. Date: Mar. 18, 2010

(54) METHOD AND SYSTEM OF SALES PROMOTION

(76) Inventor: Paul Tweedie, Penrose (NZ)

Correspondence Address: GREER, BURNS & CRAIN, 300 S WACKER DR, 25TH FLOOR, CHICAGO, IL, 60606, US

(21) Appl. No.: 12/516,762

(22) PCT Filed: Sep. 19, 2007
(86) PCT No.: PCT/NZ2007/000275

§ 371 Date: Aug. 26, 2009

(30) Foreign Application Priority Data
Nov. 30, 2006 (NZ) 551690

(51) Int. Cl. G06Q 30/00; G06F 3/048

(52) U.S. Cl. 705/14.14; 715/810

(57) ABSTRACT

A method of sales promotion using a networked computer system including the steps of:
a. presenting an electronic grid comprising a plurality of cells to a customer after conducting a sales transaction;
b. assigning a multitude of rewards to a number of cells in the grid;
c. permitting a customer to select at least one cell to reveal a selected reward;
d. calculating discounted purchase amount in relation to an amount of the sales transaction, if the customer selected cell in step c has been assigned one reward in step b;
e. electronically crediting the corresponding discounted purchase amount to a customer account, and
f. confirming of the corresponding discounted purchase amount to the customer.

### STATEMENT OF CORRESPONDING APPLICATIONS

This application is based on the Provisional specification filed in relation to New Zealand Patent Application Number 551690, the entire contents of which are incorporated herein by reference.

### TECHNICAL FIELD

The present invention relates to a method and system of sales promotion. In particular, the present invention relates to a method of sales promotion using a networked computer system that rewards customer purchases and encourages loyalty at online stores or at retail outlets having electronic point of sales. The present invention includes an element of skill/luck/satisfaction to enhance the sales transmission.

### BACKGROUND ART

Online customer purchase promotion and loyalty methods are known. Such methods include accumulation of points as a result of online purchases made from a merchant's website and subsequent redeeming of an accumulated points total from an award specified by the program. The award may be in the form of a coupon or free gift.

The disadvantage with such methods is that an award is not made after each online purchase is made and does not occur in real-time as part of the online purchase. Consequently the ability of such methods to promote sales and loyalty to the participating merchant's websites is not maximised.

Use of online scratch cards to redeem awards is also known. WO0148712A1 discloses an online lottery game over a wireless network utilising a simulated scratch card and WO0207833 discloses an emailed online ticket containing an electronic scratch card.

These methods are limited in that they are of use by themselves only and are not associated with a retail online purchase to promote sales and loyalty from a particular merchant's website.

Accordingly, it is an object of the present invention to provide a flexible method of sales promotion which can be used at an online point of sale or after a retail sale has been made and featuring the advantages of a real-time simulated scratch card win or lose situation where special discount rewards can be easily incorporated at short notice into the method.

In addition, it is a further object of the present invention to create an element of fun/satisfaction at the time of sale and to provide a

Further aspects and advantages of the present invention will become apparent from the ensuing description which is given by way of example only.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### DISCLOSURE OF INVENTION

According to one aspect the present invention there is provided a method of sales promotion using a networked computer system including the steps of:
a. presenting an electronic grid comprising a plurality of cells to a customer after conducting a sales transaction;
b. assigning a multitude of rewards to a number of cells in the grid;
c. selection of at least one cell by a customer to reveal a selected reward;
d. calculating a discounted purchase amount in relation to a retail purchase, if the customer selected cell in step c has been assigned one reward in step b;
e. either, electronically crediting the corresponding discounted purchase amount to a customer account, or, subsequently awarding the customer an award equivalent to the discounted purchase amount, and
f. confirmation of the corresponding discounted purchase amount to the customer;
   wherein the step e of electronically crediting a corresponding discount amount to a customer account occurs in real-time before the step f confirmation of the corresponding discounted purchase amount to the customer;
   and wherein the rewards may be assigned to the plurality of cells with or without reference to the retail purchase;
   and wherein the discounted purchase amount may be made at a point of sale or after a sale has been made.

For the purposes of the specification the term “networked computer system” or grammatical variations thereof may refer to a computer internet or intranet system.

For the purposes of the specification the term “point of sale” or grammatical variations thereof may refer to a virtual electronic payment gateway or a physical point of sale including a terminal machine with graphical user interface, printer and data input device such as a keyboard, swipe card reader, bar code reader, finger print scanner, retinal scanner, or similar.

For the purposes of the specification the term “reward” or grammatical variations thereof may refer to a discount or prize.

It is envisaged the customer may be identified by previously entering identification information in the form of an email address or username/password login details, or the like, so that the step 5 of electronically crediting a corresponding discount purchase amount to a customer account and subsequently awarding the customer an award equivalent to a discount purchase amount may be made.

In preferred embodiments the at least one cell may be one cell.

In preferred embodiments the number of cells per grid may be in the range 4 to 1,000,000 cells.

It is envisaged the rewards may be percentage rewards or fixed rewards. In preferred embodiments the rewards may be percentage rewards. In more preferred embodiments the percentage rewards may be between 1% and 100%. In preferred embodiments there may be at least one cell having a reward of 100%.

In preferred embodiments there may be at least 20% of the cells per grid which have an associated reward.

In preferred embodiments the discount amounts may be assigned to the plurality of cells without reference to the retail purchase.

It is envisaged at least one cell may be selected by the customer by clicking or scratching a cell with a computer peripheral device such as a mouse or pen, or the like.

In preferred embodiments confirmation of the corresponding discount amount to the customer may be made via email, visual graphic display or a letter.

In preferred embodiments if the method is aborted before step f of confirmation of the corresponding discount purchase amount to the customer then the method may be repeated from step a of presenting an electronic grid comprising a plurality of cells at a point of sale to a customer.

In preferred embodiments an award equivalent to a discount purchase amount may be a cheque, money order, voucher or gift.

It is envisaged the graphic design of the electronic grid comprising a plurality of cells may be adapted depending on the application of the method of the present invention. For example, special discount rewards can be easily incorporated at short notice into the method.

In preferred embodiments the method may include the additional step of revealing the rewards of the non-selected cells subsequent to the step f of confirmation of the corresponding discount purchase amount to the customer

It is envisaged the method of the present invention may in use utilise a number of components including:
a networked host computer system which includes the scratch grid customer page (accessible by customers directly or via participating merchants online sites) and an administration area containing user account details (accessible by participating merchants);
participating merchants computer systems networked to the host computer server and including virtual customer point of sales and an administration area containing merchant details such as the format of the merchant specific scratch grid including range of discount amounts to be applied to the scratch grid (accessible by the host computer server), and
associated physical point of sales terminals networked to the host computer server and including a terminal machine, touch sensitive graphical user interface, printer and an input device such as a swipe card reader or barcode reader.

It is envisaged the system of the present invention may have security features including: encryption of the information between the user interfaces and the server such as 128 bit encryption; prevention of a customer re-entering the previous grid graphic display to select a different cell(s) from the grid for the same initial purchase; imposing of a time expiry of an award after which the award may not be redeemed.

Thus, preferred embodiments of the present invention may have a number of advantages over the prior art which can include:
a flexible promotional tool to increase sales at a point of sale for a retail purchase or remote from a point of sale after a retail purchase;
real-time crediting of a discount amount or award to a customer electronic account, and
discount amounts assigned randomly to a plurality of cells on a grid or in relation to the retail purchase.

### BRIEF DESCRIPTION OF DRAWINGS

Further aspects of the present invention will become apparent from the following description which is given by way of example only and with reference to the accompanying drawings in which:

FIG. 1 shows a schematic view of an online scratch grid of the present invention before a customer selects a cell from the grid;

FIG. 2 shows a schematic view of an online scratch grid of the embodiment shown in FIG. 1 after a customer selects a cell from the grid;

FIG. 3 shows a schematic view of an online scratch grid of the embodiment shown in FIG. 1 after a customer selects a cell from the grid but subsequent to confirmation of the corresponding discount amount to the customer;

FIG. 4 shows a process chart illustrating the interaction of host and merchant computer systems to bring about the embodiment shown in FIG. 1 via an online point of sale with customer payment by credit card;

FIG. 5 shows a process chart illustrating the interaction of host and merchant computer systems to bring about the embodiment shown in FIG. 1 via an online point of sale with customer payment by cheque or bank deposit, and

FIG. 6 shows a process chart illustrating the interaction of host and merchant computer systems to bring about the embodiment shown in FIG. 1 via a physical point of sale terminal.

### BEST MODES FOR CARRYING OUT THE INVENTION

In summary the method of the present invention works like an online scratch discount card where customers can use a computer pointing device such as a mouse to select a cell on a grid to reveal a discount amount, usually expressed in terms of percentage discount figures. The range percentage discount figures on the grid can vary but usually includes at least one 100% discount cell per grid. Once a cell is selected the other yens on the grid are automatically de-selected and are unable to be selected or reactivated in relation to the current transaction.

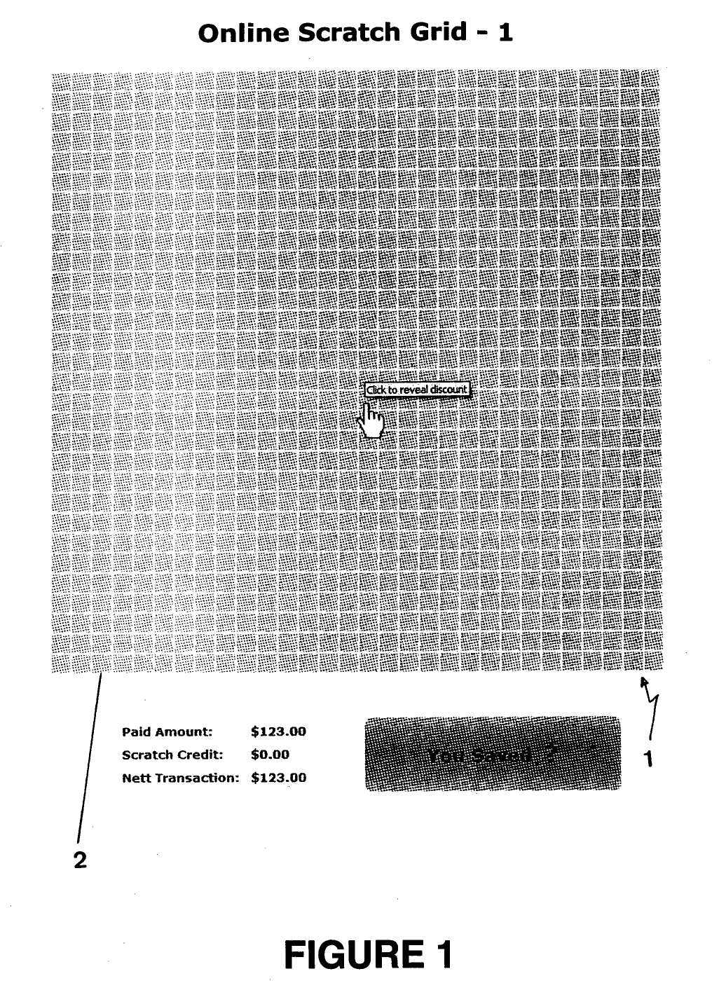

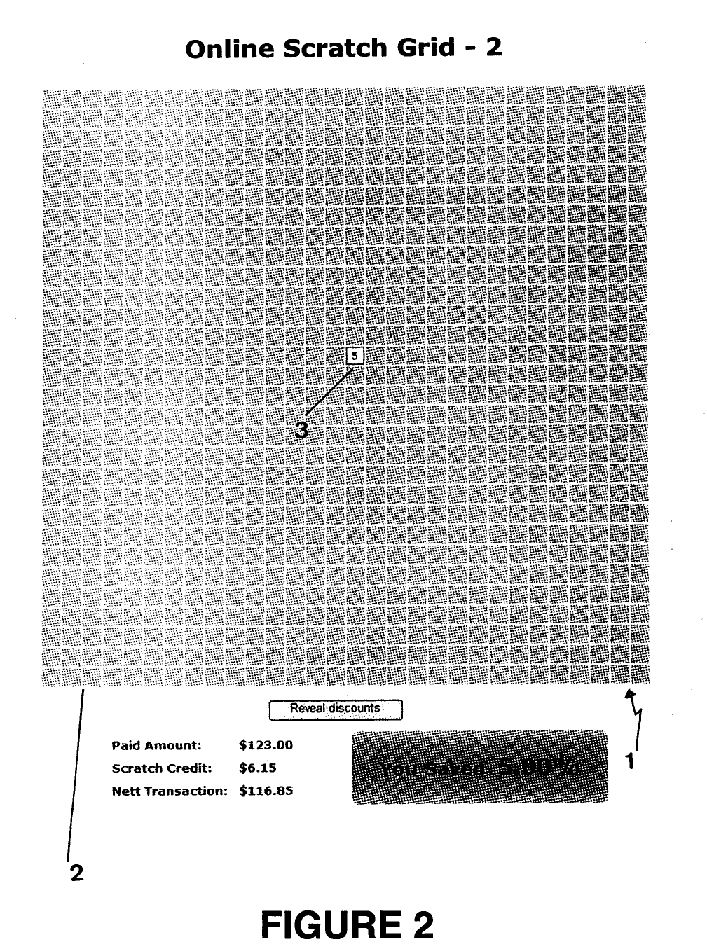

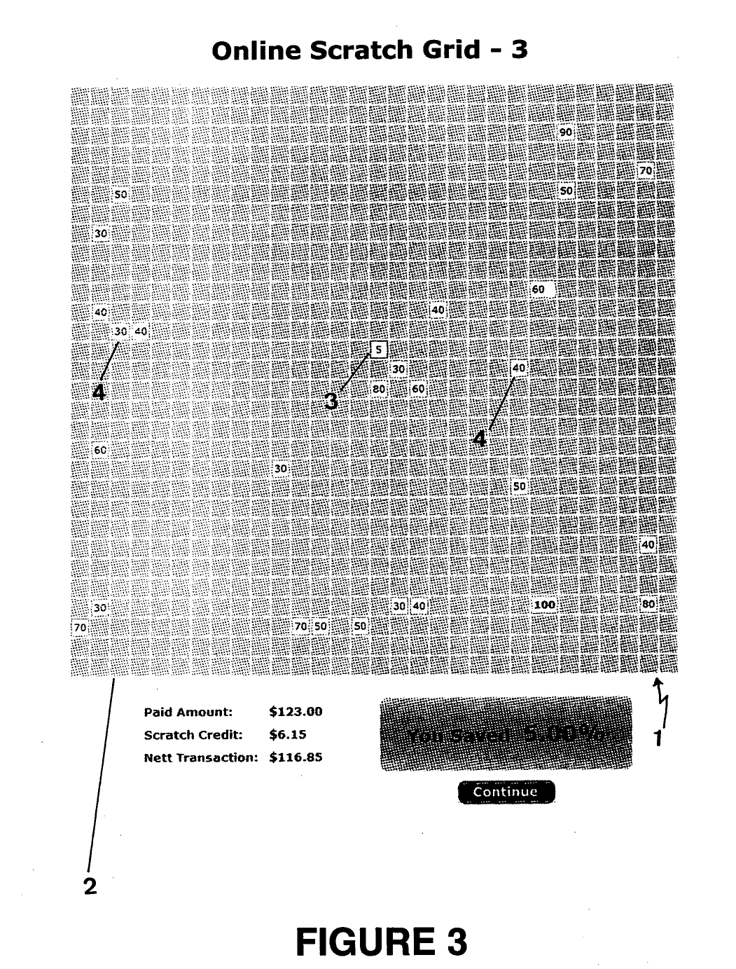

Referring to FIGS. 1 to 3 an electronic grid is generally indicated by arrow (1) comprising a plurality of cells (2) is presented to a customer (FIG. 1) who then clicks and then repeatedly moves the cursor over the selected cell (i.e. scratches) to reveal a percentage discount (3) of 5% (FIG. 2) which will be applied against their current purchase. For example, if a customer made a purchase of $123.00 and got a discount of 5% then the amount they would have credited to their account would be $6.15. The identity of the other discounts (4) which would have also been available on the grid (1) at the time the customer selected the percentage discount (3) can then be subsequently displayed to the customer (FIG. 3).

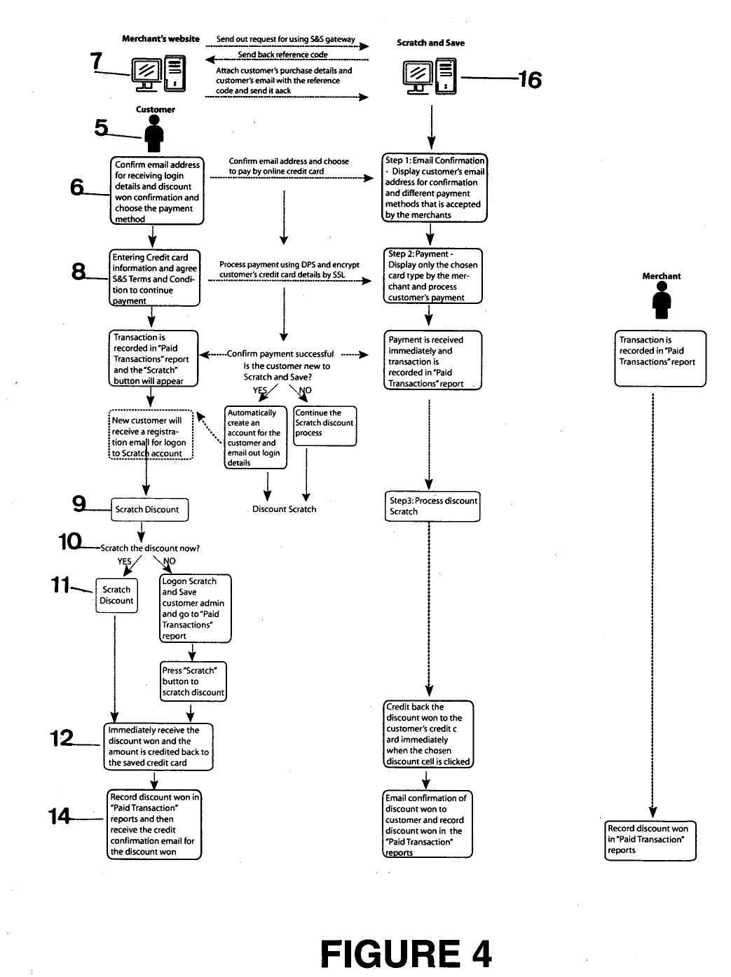

The interaction of host and participating merchants computer systems to bring about the method of the present invention shall now be described with reference to examples and FIGS. 4 to 6:

### Example 1

### Online Retail Point of Sale

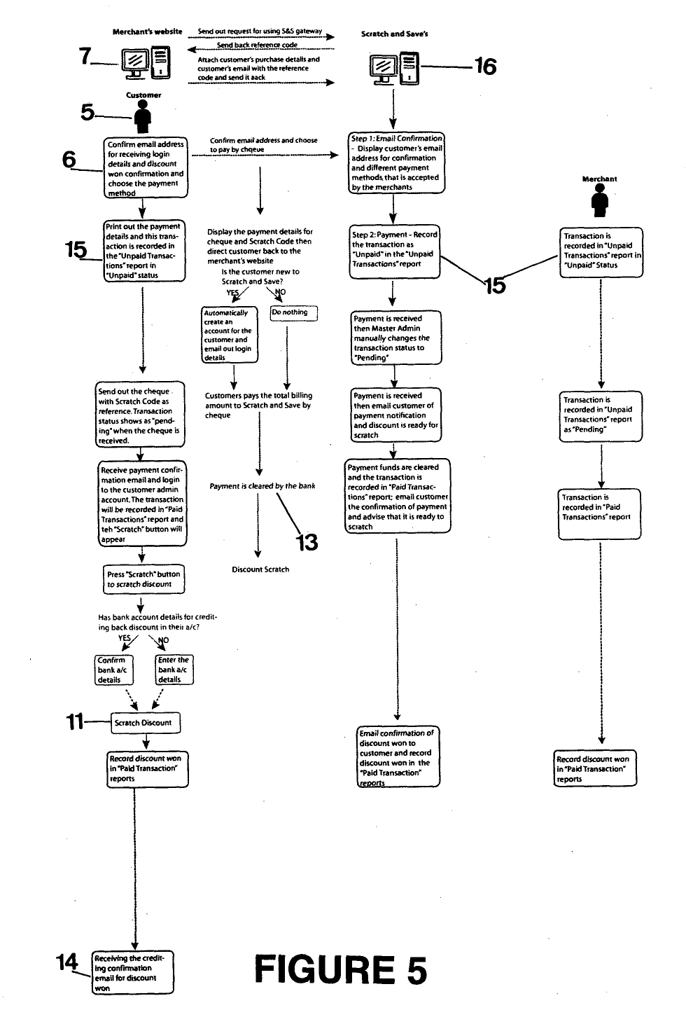

Referring to FIGS. 4 and 5, a customer (5), after entering identification information in the form of an email address (6) on a participating merchants website (7) will automatically be directed from the merchant's online retail internet or intranet site (7), where credit card information is entered and payment for a retail purchase made (8), to a dedicated webpage presenting an electronic “scratch” grid (9) comprising a plurality of cells (referred to herein as the “scratch page”) as part of the post payment checkout process.

A customer can choose to participate (10) and if desired click or scratch a cell on the electronic grid of the scratch page (11). The relative position of the selected cell is recorded into a client database as a “scratch event”. After this event occurs all discount amount values that are preset in the participating merchant's profile are randomly assigned their position on the scratch grid. Using the selected discount amount and previous purchase amount, a calculation of the monetary value of the discount amount is made. If payment was by made by credit card an automatic credit back of the discount amount to the customers credit card account (or bank account) is made (12).

If payment was made by cheque or bank deposit, payment is first cleared into a host bank account (13) before confirmation is made to the customer of the discount amount won (if any) (14). Consequently, a customer's scratch event is recorded as an unpaid transaction (15) in the merchant's computer system (7) and host's computer system (16) before payment has cleared (13). The transaction amount, less host fees, is paid to a merchant's account (not shown).

The scratch event result is then encrypted and sent back to the merchant online site where it is then unencrypted to be displayed as the discount the customer has “scratched” as confirmation (14). Optionally, the user can then click any additional cells (ones that weren't originally “scratched”) and these will display the discounts that were in the other cells (by requesting information back to the server).

Once the discount amount is revealed or displayed, the customer can go back to the previous page and refresh the current page but the result will not change.

Throughout this whole process almost all events are recorded in the host computer system (16) and participating merchant computer system (7) so they can be verified later and used for accounting purposes.

If the scratch page is closed before the discount amount is revealed or displayed the event is logged, an email with all relevant details is sent so the customer so that they will be able to log in and go to their account management page at a later stage to scratch the grid and receive their discount.

Alternatively, if no credit card (or bank card) details are available for the customer, a monetary amount equivalent to the discount amount is awarded to the customer by way of cheque or voucher after payment has been of the purchase has been cleared through an associated host bank account.

### Example 2

### Physical Point of Sale Terminal

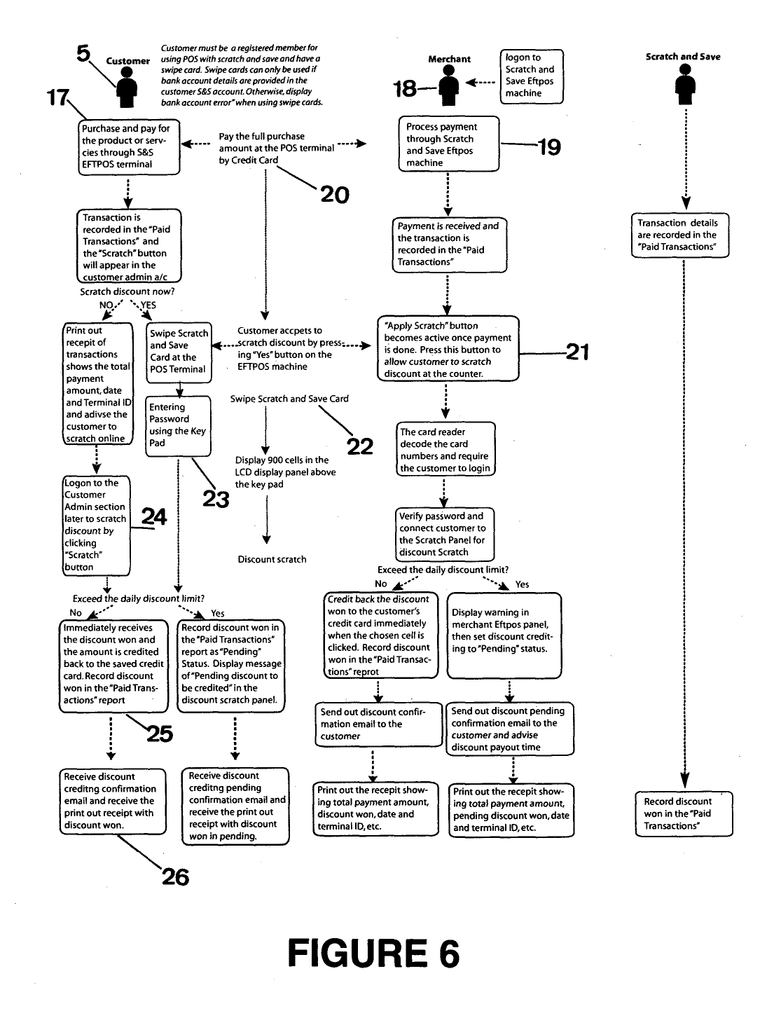

Referring to FIG. 6, a customer (5) purchases goods and/or services at a participating merchant's point of sale terminal apparatus (17). The merchant (18) enters the purchase amount on the point of sale terminal apparatus (19) and the customer (5) pays by credit card or bank card (20). The customer (5) pushes a dedicated button (21) on the point of sale terminal apparatus (17), if they would like to participate in a scratch event, which automatically log's onto the host computer server (16). The customer then swipes a financial card apparatus such as a host loyalty card (22) through the point of sale terminal apparatus and enters identification information in the form of a personal identification number (23). If payment clears then the customer the interface of the point of sale terminal apparatus displays a scratch grid (24) on which the customer can select a cell to reveal a discount percentage or amount. The discount amount is converted to a dollar amount and the transaction recorded on the host computer server. The discount amount is credited back to the customer's credit card account (25). And the transaction amount less fees is paid to the merchants account. A printed receipt is printed from the point of sale terminal apparatus for the customer (26).

Similar to example 1 above, throughout this whole process almost all events are recorded in the host computer system (16) and participating merchant computer system (7) so they can be verified later and used for accounting purposes.

### Example 3

### Manual Invoicing

Participating merchants can log onto the host computer server and access an administration page to generate invoices directly. Optionally codes may be issued with the invoices which can subsequently be used by the customer to enter into the scratch page of the host computer server to participate in a scratch event (as detailed in example 1 above).

Aspects of the present invention have been described by way of example only and it should be appreciated that modifications and additions may be made thereto without departing from the scope of the appended claims.

1. A method of sales promotion using a networked computer system including the steps of:
a. presenting an electronic grid comprising a plurality of cells to a customer after conducting a sales transaction;
b. assigning a multitude of rewards to a number of cells in the grid;
c. permitting a customer to select at least one cell to reveal a selected reward;
d. calculating discounted purchase amount in relation to an amount of the sales transaction, if the customer selected cell in step c has been assigned one reward in step b;
e. electronically crediting the corresponding discounted purchase amount to a customer account, and
f. confirming of the corresponding discounted purchase amount to the customer; wherein:
the step (e) of electronically crediting a corresponding discount amount to a customer account occurs in real-time before the step f confirmation of the corresponding discounted purchase amount to the customer;
the rewards may be assigned to the plurality of cells with or without reference to the amount of the sale transaction; and
the discounted purchase amount may be made at a point of sale or after a sale has been made.

2. A method of sales promotion using a networked computer system as claimed in claim 1 wherein the at least one cell a customer selects is one cell.

3. A method of sales promotion using a networked computer system as claimed claim 1 wherein the number of cells per grid is in the range of 4 to 1,000,000 cells.

4. A method of sales promotion using a networked computer system as claimed in claim 1 wherein the rewards are percentage rewards.

5. A method of sales promotion using a networked computer system as claimed in claim 4 wherein the percentage rewards are between 1% and 100%.

6. A method of sales promotion using a networked computer system as claimed in claim 1 wherein there is at least one cell having a reward of 100%.

7. A method of sales promotion using a networked computer system as claimed in claim 1 wherein at least 20% of the cells per grid have an associated reward.

8. A method of sales promotion using a networked computer system as claimed in claim 1 wherein the discount amounts are assigned to the plurality of cells without reference to the retail purchase.

9. A method of sales promotion using a networked computer system as claimed in claim 1 wherein the confirmation of the corresponding discount amount to the customer is made via email, visual graphic display or a letter.

10. A method of sales promotion using a networked computer system as claimed in claim 1 wherein the method is aborted before step f of confirmation of the corresponding discount purchase amount to the customer, then the method is repeated from step a of presenting an electronic grid comprising a plurality of cells at a point of sale to a customer.

11. A method of sales promotion using a networked computer system as claimed in claim 1 wherein the award equivalent to a discount purchase amount is a cheque, money order, voucher or gift.

12. A method of sales promotion using a networked computer system as claimed in claim 1 wherein the method includes the additional step of revealing the rewards of the non-selected cells subsequent to the step f of confirmation of the corresponding discount purchase amount to the customer.

13. A networked computer system using the method of sales promotion as claimed in claim 1 including:
a networked host computer system which includes a scratch grid customer page accessible by customers directly or via participating merchants' online sites and an administration area containing user account details accessible by participating merchants;
at least one participating merchants' computer system networked to the host computer system and including virtual customer point of sales and an administration area containing merchant details such as the format of the merchant specific scratch grid including range of discount amounts to be applied to the scratch grid accessible by the host computer server, and
associated physical point of sales terminals networked to the host computer server and including a terminal machine, touch sensitive screen, printer and an input device such as a swipe card reader or a barcode reader.
